(19) United States
(12) Patent Application Publication
(10) Pub. No.: US 2015/0317586 A1
(43) Pub. Date: Nov. 5, 2015

(54) SYSTEM FOR ALLOCATING AND COSTING DISPLAY SPACE

(71) Applicant: Ari M. Kassman, Long Beach, NY (US)

(72) Inventor: Ari M. Kassman, Long Beach, NY (US)

(21) Appl. No.: 14/676,475

(22) Filed: Apr. 1, 2015

Related U.S. Application Data
(60) Provisional application No. 61/987,191, filed on May 1, 2014.

(51) Int. Cl. G06Q 10/06; G06Q 40/02; G06Q 30/06

(52) U.S. Cl. CPC G06Q 10/06313; G06Q 30/0645; G06Q 40/025

(57) ABSTRACT

A system and method are provided for a display space allocation and costing system, allowing direct access by companies or individuals seeking a place to sell goods.

### CROSS-REFERENCE TO RELATED APPLICATIONS

This application claims the benefit of U.S. Provisional Patent Application No. 61/987,191 filed May 1, 2014, the disclosure of which is incorporated herein by reference in its entirety.

### BACKGROUND OF THE INVENTION

### Field of the Invention

This invention relates to a system for the allocating and costing of retail display space. Despite the popularity of catalog and Internet shopping, brick-and-mortar stores remain very important, with hundreds of millions of square feet of display space installed. Product placement has become an important science for manufacturers, distributors, and retailers. For example, smaller brands, regional brands, and gourmet brands might occupy a top shelf, with the second and third shelves having best-sellers, national brands, and high-margin products, and the bottom shelf having bulky and oversized products. While a store manager would recognize that he must carry certain items, for example, a grocer would need to carry staples such as milk and bread, as well as certain brands of laundry detergents, the retailer still has great latitude in determining which brands and products will receive shelf space in his store. This invention describes a system allowing retailers to rent a percentage of the shelf space in their stores to interested parties, which could be wholesalers, manufacturers, or speculators. The shelf space made available for rental is described by location within the store, width, depth and height of retail space available, vertical position of shelf within a stack of shelves, etc.

It is therefore an object of the present invention to provide a hardware and software platform, including analytical model and data sets, for allocating and costing display space.

### BRIEF SUMMARY OF THE INVENTION

The above objects and further advantages are provided by the methods and systems for allocating and costing retail display space.

According to one aspect of the present invention a system and method are provided for the allocation and costing of retail display space.

It is a further object of the present invention to disclose one embodiment of a hardware interface for a display space allocation and costing system, in which the hardware interface provides a shelf product monitor system.

### BRIEF DESCRIPTION OF THE DRAWINGS

The invention will be described in further detail below and with reference to the attached drawings in which the same or similar elements are referred to by the same or similar reference numerals, in which:

FIG. 1 is a block diagram of a display space allocation and costing system for the trading of retail shelf space; and

FIG. 2 is a block diagram of one embodiment of a hardware interface for the display space allocation and costing system.

### DETAILED DESCRIPTION OF THE INVENTION

The present invention broadly comprehends a display space allocation and costing system allowing retailers to list a percentage of their store's shelf space on the system, while manufacturers, wholesalers, or speculators can bid on leasing the display space.

Reference will now be made in detail to implementations of the invention, examples of which are illustrated in the accompanying drawings.

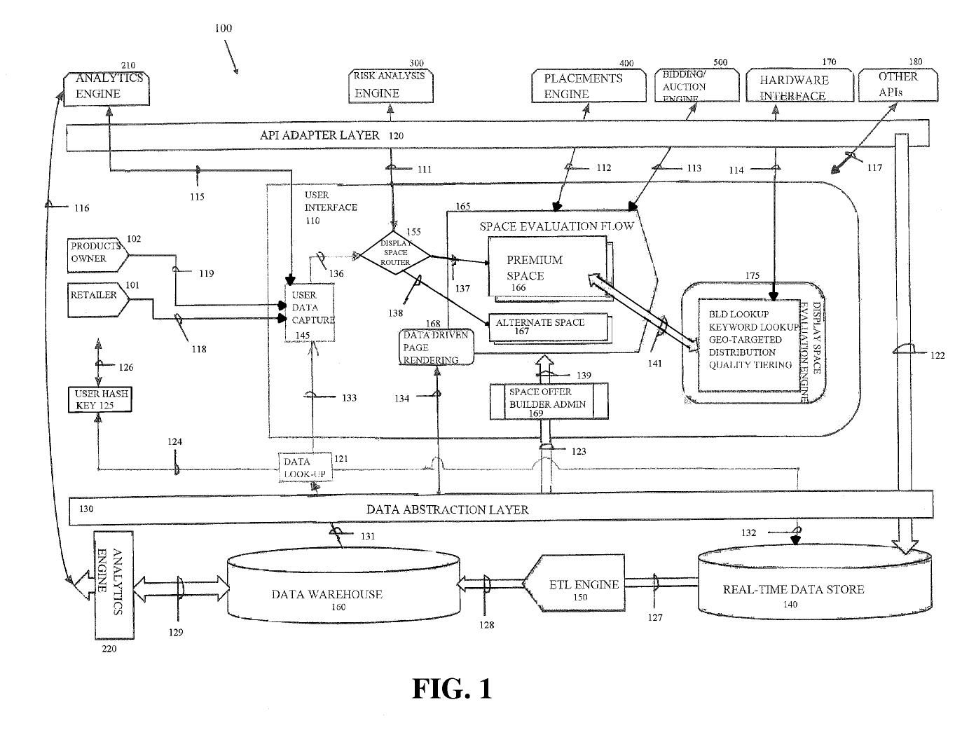

FIG. 1 illustrates an embodiment of a display space allocation and costing system 100, in which proprietary hardware and software uses statistical and behavioral metrics to make recommendations to users. In this embodiment, users of the system, which will include both retailers 101 who have ownership or control of retail display space, as well as product owners 102, middle-men, speculators, or others who are interested in leasing display space from retailers 101. The users, retailers 101 and product owners 102 use the display space allocation and costing system 100 by utilizing user interface 110.

User interface 110 communicates with and controls a number of hardware and software components including an analytics engine (analytics front end 210 and analytics engine back end 220), risk analysis engine 300, placements engine 400, bidding/auction engine 500, hardware interface 170, real-time data store 140, and data warehouse 160. User interface 110 also communicates with data look-up 121 and user hash key module 125. user interface 110 includes the visual interface that is displayed to the user, and also includes user data capture 145, which is a client-side ‘beacon’ script that monitors as the user moves through the system, with user hash key attached, and is acquired securely by each aspect of the system flow. This process enables us to track everything that the user does in the system, furthering the system's ability to make better recommendations for the users, and to provide better security.

A virtual private network (VPN) accessible API adapter layer 120 facilitates the communications between user interface 110 and analytics engine front end 210, risk analysis engine 300, placements engine 400, bidding/auction engine 500, and hardware interface 170. As understood to one of ordinary skill in the art, API adapter layer 120 is an interface that allows binary data from a foreign system to run on a host system. System calls for the foreign system are translated by API adapter layer 120 into native system calls for the host system. In conjunction with libraries for the foreign system, this will allow the host system to run binaries of the foreign systems.

Additional application programming interfaces (APIs) 180 are provided, including APIs that handle miscellaneous third party data and validation services; profiling; decision-making for the allocation and costing system; risk management; incident management; credit worthiness. The APIs also handle dynamic creation and stacking of new layers, for example, extending the capabilities of display space allocation and costing system 100 by allowing it to work with a third-party's system, so that the two systems together create a new function that is defined as an additional layer in the system that is enabled by additional application programming interfaces (APIs) 180. Additional APIs 180 communicate with user interface 110 via other APIs data path 117.

A data abstraction layer 130, as is understood to one of ordinary skill in the art, is an application programming interface that unifies communication between user interface 110 and the databases, real-time data store 140 and data warehouse 160. As is understood by one of ordinary skill in the art, the massive amounts of data available to complex systems favor the use of a real-time data store in conjunction with offline data warehousing, with different storage practices for the data stored in the different areas, correlating to the amount of times per day that data needs to be accessed, as well as by the number of people requiring access to particular data. For example, the price of a unit of a product, or the fee for slotting a specific space, would be an example of data requiring real-time storage. The data contained in a user profile, which is not factored and used in the system's dynamic decision-making, is an example of data that can be stored in a data warehouse.

Real-time data store 140 receives data originating from multiple sources that pertain to the allocation and costing of retail display space. The data is integrated which can include known techniques of data scrubbing, resolving redundancy and checking against business rules for integrity. One source of data is data look-up 121, which communicates with real-time data store 140 via real-time data store to data look-up module data path 132. Another source of data is from data abstraction layer 130 and API adapter layer 120 via API adapter layer to data abstraction layer data path 122.

After processing in real-time data store 140, data is passed to an extract-transform-load (ETL) engine 150 via real-time data store to ETL engine data path 127.

ETL engine 150 extracts data from the various data sources input into real-time data store 140, transforms the data for storing it in proper format or structure for querying and analysis, and loads it into data warehouse 160 via ETL engine to data warehouse data path 128. The function of an ETL engine is well-known to one of ordinary skill in the art.

Data warehouse 160 is a backend database storage layer/system that contains much greater amounts of data than the real-time data store, with the data arranged into hierarchical groups (“dimensions”), facts and aggregate facts. Data warehouse 160 is a central repository of integrated data that stores current and historical data relevant to the allocation and costing of display space. It is used to create trending reports that will serve both the retailers 101 and product owners 102. Data warehouse 160 communicates to data look-up 121 via data abstraction layer 130 and data warehouse to data look-up module data path 131. Data warehouse 160 also communicates to analytics engine back end 220 via data warehouse to analytics engine data path 129.

User interface 110 includes a number of components, including user data capture module 145, display space router 155, space evaluation flow module 165, data driven page rendering module 168, space offer builder admin module 169, and display space evaluation engine 175.

Space evaluation flow module 165 includes premium space selection module 166, alternate space selection module 167, and data driven page rendering module 168. The user is presented with choices, with premium space selection module 166 providing a preferred choice, and alternate space selection module 167 providing an alternate choice. In one embodiment, display space allocation and costing system 100 will charge transaction fees relating to the leasing of display space, and if it can increase the arbitrage for the users, it can charge larger transaction fees.

Hardware interface 170 includes a software development kit (SDK) interface. In a preferred embodiment, an open SDK is employed, allowing various developers to build hardware and software applications on top of the proprietary display space allocation and costing system 100. External physical devices' access to display space allocation and costing system 100 is supported via a secured internet protocol security (IPSec), with a virtual private network (VPN) accessible API adapter layer 120. Hardware interface 170 communicates bidirectionally with display space evaluation engine 175 of user interface 110, via API adapter layer 120 and hardware interface data path 114.

The analytics engine, as noted above, includes both an analytics engine front end 210 and an analytics engine back end 220, which communicate with each other via analytics engine internal bus 116. The analytics engine provides a system to organize, process and prepare all internally- and externally-available data for use in the display space allocation and costing system 100. The analytics engine is used to perform a variety of tasks for the user, such as identifying sell-through timing (the length of time a product sits on the shelf), which products sell best in a particular neighborhood, the price paid on average for a product in a particular neighborhood, and the number of free cases needed to be given to a retailer to lower the retailer's overall cost. Analytics engine front end 210 communicates bidirectionally with user data capture module 145 of user interface 110, via API adapter layer 120 and analytics engine data path 115.

Placements engine 400 is a deterministic system incorporating all known data points to provide a best-placement solution for a product onto a given shelf space. Data points for a given shelf space include location of the store, location of the shelf space within the store, dimensions and height of the shelf space, height above the floor, and the length of time a lease is available. Placements engine 400 is used to find a space for a product, or conversely, to find a product to fit a particular space based upon specific products that consumers are purchasing from similar stores in similar areas. Placements engine 400 communicates bidirectionally with space evaluation flow module 165 of user interface 110, via API adapter layer 120 and placements engine data path 112. A data append function allows for additional data retrieved by placements engine 400 to be added to space evaluation flow module 165. For example, if a product owner 102 wants to place an item in a store located in New York, the data is sent to placements engine 400. Placements engine is not limited to acting on this data, however, but can instead suggest a different location or course of action, for example based on data that the item might sell better in a different location.

Risk analysis engine 300, described in greater detail below, is a deterministic peer-influenced system incorporating internal and external data sources to perform validation, fraud check, and risk analysis for users of display space allocation and costing system 100. This stratified application accounts for both risk of network peers and risk of transaction. Network peer ranking are based on offline information such as past bankruptcies, if any, whereas risk of transaction is based with in-store concerns such as lack of sell-through or lack of consumer traffic. Risk analysis engine 300 communicates bidirectionally with display space router 155 of user interface 110, via API adapter layer 120 and risk analysis engine data path 111. In this manner, risk analysis engine 300 accesses user data that has been generated and stored from other API engines.

Bidding/auction engine 500 provides a real-time bidding system for commoditizing the shelf space. It helps determine the price and relative overall value, including sell-through proportions, enabling the user to intelligently bid and lease space. Bidding/auction engine 500 communicates bidirectionally with space evaluation flow module 165 of user interface 110 via API adapter layer 120 and risk analysis engine data path 113. A retargeting integration function, similar to the data append function described for placements engine 400, allows bidding/auction engine 500 to recommend a course of action that might dynamically modify the flow of the user's choices through the system. For example, display space allocation and costing system 100 has the ability to suggest stores in a different geographic location than the one product owner 102 inputs into the system.

User data capture module 145 receives communication from the users of the display space allocation and costing system 100. For example, user data capture module 145 can collect details of display spaces, and can query retailer 101 about annual sales. Retailer 101 communicates with user data capture module 145 via retail user to user data capture module data path 118. Product owner 102 communicates with user data capture module 145 via products owner to user data capture module data path 119. As is understood by one of ordinary skill in the art, retail user to user data capture module data path 118 and products owner to user data capture module data path 119 can be a connection via the Internet, via a smartphone application, via a hardwired line, etc.

User data capture module 145 receives communications from data look-up 121 via data look-up module to user data capture module data path 133. Data about the user's previous purchases is made available via this path. User data capture module 145 also communicates with display space router 155, via user data capture module to display space router data path 136.

Data look-up 121 is an object space provided in memory that serves as a security buffer preventing users from ever having direct access to data warehouse 160. Data warehouse 160 pushes data into data look-up 121 via unidirectional data warehouse to data look-up module data path 131. Data look-up 121 creates global identifiers that are used throughout display space allocation and costing system 100.

As part of a security protocol, retailer 101 And product owner 102 are provided with a user hash key via user hash key module 125, which generates the hash key and verifies it as unique via data warehouse 160. The hash key is a security token provided to a user via their first interaction with display space allocation and costing system 100. User hash key module 125 communicates with data look-up 121 via data look-up module to user hash key module data path 124. User hash key module 125 communicates the hash keys to the users via user hash key module to user data path 126.

Display space router 155 receives requests for a display space from product owner 102, communicating with placements engine 400 and display space evaluation engine 175. Display space router 155 returns display space requests to the retailer 101. Display space router 155 communicates with space evaluation flow module 165. Specifically, display space router 155 communicates with premium space selection module 166 via display space router to premium space selection module data path 137, and it also communicates with alternate space selection module 167 via display space router to alternate space selection module data path 138.

Data driven page rendering module 168 dynamically provides elements of a user-experience based on the known data in the system and at the run-time of the user experience. It overlaps with space evaluation flow module 165. All pages on the system are assembled from database calls, rather than being static files of information. Data driven page rendering module 168 receives communications from data abstraction layer 130 via data abstraction layer to data driven page rendering module data path 134.

Space offer builder admin module 169 is utilized by retailer 101 to add available retail space to display space allocation and costing system 100 and to administrate the listing of that entry. Space offer builder admin module 169 receives communications from data abstraction layer 130 via data abstraction layer to space offer builder admin module 123. Space offer builder admin module 169 communicates with space evaluation flow module 165 via space offer builder admin module to space evaluation flow module data path 139.

Display space evaluation engine 175 provides a final evaluation for the best choices presented to the user. Display space evaluation engine 175 communicates bidirectionally with premium space selection module 166, via space evaluation flow module to premium space selection module data path 141.

In addition to the direct connections shown in FIG. 1, indirect communications are also common. For example, it has been described above that a user's bidding history collected by bidding/auction engine 500 is passed to display space router 155 via API adapter layer 120 and risk analysis engine data path 111. However, the data can also be accessed by risk analysis engine 300 via a circuitous path through real-time data store 140, data warehouse 160, data abstraction layer 130, data look-up module 121, user interface 110, and API adapter layer 120.

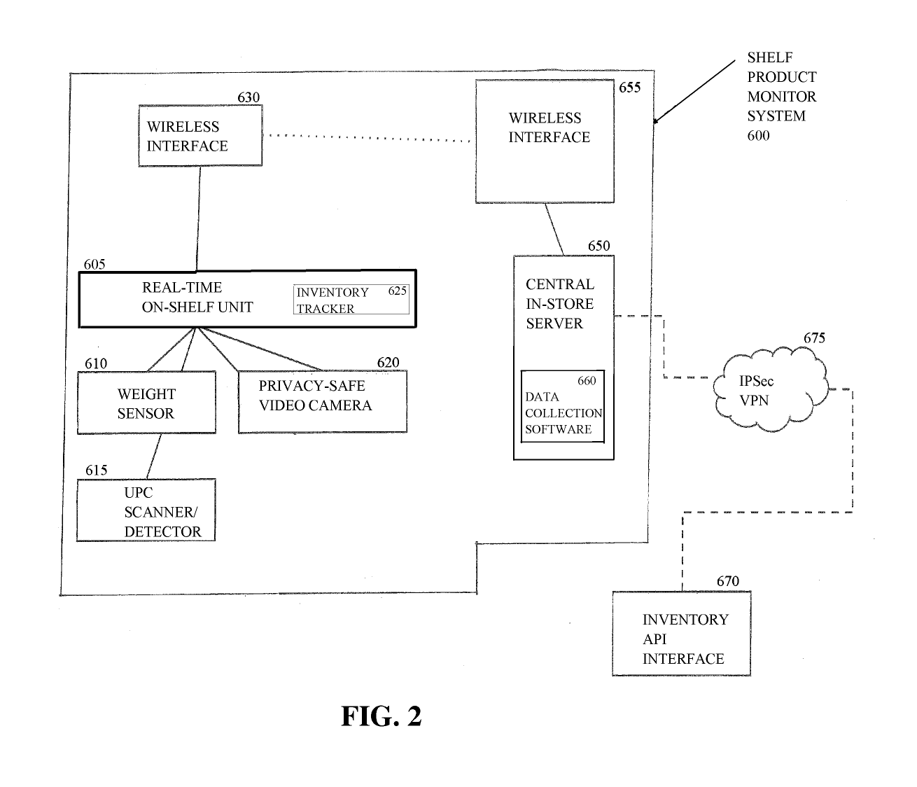

FIG. 2 shows an example of a shelf product monitor system 600 that is installed in a retail establishment. This is one embodiment of hardware interface 170 as shown on FIG. 1.

Small retailers who maintain product stores have no method to track inventory or customer acquisition information via a web-based or mobile-based product. UPC and Nielsen data compilations are available post-monthly for stores that have a modern point-of-sale system that supports such a feature. However, independent store owners have no way to determine how many people browsed by a specific shelf, in a given month, or on a particular day. A store owner could benefit from such data, if available, and additionally would benefit by learning if customers picked up a product from the shelf, examined it and returned it to the shelf without purchase. This type of data would aid a retailer in making various determinations, such as deciding which products to reorder, or deciding to physically reposition an item within the store for added exposure. Historically, such data has only been available to very large enterprise stores that hire a consultant who may provide a human to monitor this information. No service exists to allow small and medium retailers to have this same ability, and certainly not in real-time via a web-based or mobile-based application.

Shelf product monitor system 600 includes both a real-time on-the-shelf unit 605 and a central in-store server 650.

Real-time on-the-shelf unit 605 incorporates a microprocessor and memory, as well as interfacing with either a self-contained or weight sensor 610, UPC scanner/detector 615, privacy-safe video camera 620, inventory tracker 625, and wireless interface 630. The unit can sit unnoticed below a store shelf, out of the view of the customer.

Weight sensor 610 provides an indication of how much product is on a shelf, as well as whether a customer has lifted a product from the shelf, e.g., for inspection.

UPC scanner/detector 615 provides for monitoring the presence of inventory.

Privacy-safe video camera 620 can provide the shelf product monitor system 600, and in turn the display space allocation and costing system 100, with data such as the amount of time that a customer spends at a shelf inspecting the product being displayed, and can employ fuzzy logic techniques to determine demographics data, such as age-range, gender, race, etc. of the customers showing an interest in the product on display.

Inventory tracker 625 is a software component that is stored in the memory of, and that is executed by the microprocessor of, real-time on-shelf unit 605. Inventory tracker 625 accepts data from components such as weight sensor 610, UPC scanner/detector 615, and privacy-safe video camera 620, determining product totals, which assists a user in tracking overall product sales as well as shrinkage.

Wireless interface 630 allows the real-time on-the-shelf unit 605 to communicate with the central in-store server 650.

The memory includes a program that runs on the microprocessor, monitoring and processing data received from weight sensor 610, UPC scanner/detector 615, privacy-safe video camera 620, and that transmits the data via wireless interface 630 to central in-store server 650.

Central in-store server 650 communicates with the real-time on-the-shelf unit 605 via its own wireless interface 655. Central in-store server 650 also incorporates data collection software 660.

The shelf product monitor system 600 communicates with the display space allocation and costing system (not shown, appears as element 100 on FIG. 1) via inventory API via a virtual private network 675 and inventory API interface 670 (which appears as Other APIs 180 on FIG. 1). Thus, data gathered by the real-time on-the-shelf unit 605 can be tracked by its self-contained microprocessor, can be transmitted wirelessly to central in-store server 650, and then sent via secured VPN tunnel 675 to the inventory API service 670 of display space allocation and costing system 100. Via the API service 670, data gathered by the real-time on-the-shelf unit 605 can be provided to the retailer or to a third party, via mobile application, email, or web notification, as selected by the user.

The system of the present invention has been described above and with reference to the attached drawings; however, modifications will be apparent to those of ordinary skill in the art and the scope of protection for the invention is to be defined by the claims that follow.

I claim:

1. An automated system for the allocating and costing of retail display space, the system comprising:
a memory that stores program modules and data;
a processor coupled to the memory;
a user interface program module executable by the processor for receiving input from system users for processing and for storage into the memory;
an analytics engine program module executable by the processor for organizing, analyzing and aggregating statistical data, including statistical data stored in the system's memory and statistical data imported from sources external to the system; and
a placements engine program module executable by the processor for analyzing the user input received by the user interface program module, the statistical data aggregated by the analytics engine program, and other stored and/or retrieved information to best allocate the retail display space, and to store the best allocation of the retail display space to the memory.

2. The automated system for the allocating and costing of retail display space of claim 1, further comprising a risk analysis engine program module for analyzing credit worthiness of the system users.

3. The automated system for the allocating and costing of retail display space of claim 1, further comprising a bidding/auction engine program module executable by the processor to allow the users who control the retail display space to list a portion of their retail display space for lease by auction, and to allow the users who seek to lease the listed portion of the retail display space to bid on the listed portion of the retail display space listings.

4. The automated system for the allocating and costing of retail display space of claim 1, wherein the stored and/or retrieved information available to the placements engine program module for a given retail display space includes: a location of a store containing the retail display space; a location of the retail display space within the store; a length, width, and height of the retail display space; a height of the bottom of the retail display shelf above the floor; and a length of time for which a lease of the retail display space is offered.

5. A real-time on-the-shelf monitor unit comprising:
a memory that stores program modules and data;
a processor coupled to the memory;
a weight sensor;
a privacy-safe video camera; and
a wireless transceiver;
wherein the program modules are executable on the processor and are capable of: monitoring the weight sensor, the privacy-safe video camera, and the wireless transmitter; saving information gathered from the monitored elements to the memory; and transmitting the information gathered from the monitored elements via the wireless transmitter.

6. The real-time on-the-shelf monitor unit of claim 5, further comprising a UPC scanner/detector.

7. A shelf product monitor system comprising:
a real-time on-the-shelf monitor unit comprising a first memory that stores program modules and data; a first processor coupled to the first memory; a weight sensor; a privacy-safe video camera; and a first wireless transceiver; and
a central in-store server, comprising a second memory that stores program modules and data; a second processor coupled to the second memory; a second wireless transceiver; and data collection software stored in the second memory and that is executable on the second processor;
wherein the program modules in the first memory are executable on the first processor and are capable of: monitoring the weight sensor, the privacy-safe video camera, and the wireless transmitter; saving information gathered from the monitored elements to the memory; and
transmitting the information gathered from the monitored elements via the first wireless transceiver to the second wireless transceiver.

8. The automated system for the allocating and costing of retail display space of claim 1, further comprising a real-time on-the-shelf monitor unit comprising:
a monitor unit memory that stores monitor unit program modules and monitor unit data;
a monitor unit processor coupled to the monitor unit memory;
a weight sensor;
a privacy-safe video camera; and
a wireless transmitter;
wherein the monitor unit program modules are executable on the monitor unit processor and are capable of: monitoring the weight sensor, the privacy-safe video camera, and the wireless transmitter; saving information gathered from the monitored elements to the monitor unit memory; and transmitting the information gathered from the monitored elements via the wireless transmitter to the analytics engine program module.

9. A method for the allocating and costing of retail display space, the method comprising:
receiving input from system users and storing it into memory;
organizing, analyzing and aggregating statistical data, including statistical data stored in the system's memory and statistical data imported from sources external to the system; and
analyzing user input, statistical data, and other stored and/or retrieved information to best allocate retail display space, and to store the best allocation to the memory.
